(19) United States
(12) Patent Application Publication
(10) Pub. No.: US 2010/0057640 A1
(43) Pub. Date: Mar. 4, 2010

(54) Method of creating a pricing schedule for use by a pharmaceutical pricing system

(76) Inventor: Michael C. Cannata, Bloomingdale, IL (US)

Correspondence Address: MCCRACKEN & FRANK LLP, 311 S. WACKER DRIVE, SUITE 2500, CHICAGO, IL, 60606, US

(21) Appl. No.: 12/229,765

(22) Filed: Aug. 27, 2008

(51) Int. Cl. G06F 17/00

(52) U.S. Cl. 705/400

(57) ABSTRACT

A method of creating an electronic pricing schedule for use by a pharmaceutical pricing system includes the steps of determining an average wholesale price (“AWP”) for a quantity of a drug, determining a median sales price (“MSP”) for the quantity of the drug, wherein the MSP is based on historical sales data, and determining a discount rate based on the quantity of the drug. The method further includes the steps of calculating a gross profit percentage (“GP %”), wherein the GP % is based on the AWP, the MSP, and the discount rate, and generating an electronic pricing schedule, wherein the drug is associated with the GP %.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to a method of creating a pricing schedule for use by a pharmaceutical pricing system.

2. Description of the Background of the Invention

Providing prescription drugs to patients involves a complex system of drug distribution that includes a number of players, including manufacturers, wholesalers, and retailers. Each of these players participates in the pricing of generic and brand name drugs as purchasers or providers and sometimes both and, therefore, the pricing of prescription drugs is highly complex.

The manufacturer sells the drug to a wholesaler and establishes a price that varies by the form and strength, and sometimes package size, of the product. When there is only a single manufacturer of a drug, as is often the case with a brand name drug, there is generally only one price for a specific product. Once generic versions of the drug become available, however, the equivalent medication may be offered at different prices by different manufacturers.

Wholesalers may sometimes receive discounts from manufacturers, based on volume or prompt payment. A manufacturer of a multi-source drug (i.e., one that is produced by more than one manufacturer, such as a generic drug) may also offer a discount to induce wholesalers to promote its particular version of the drug. Thus, for any particular drug, the price may more closely reflect the market position of the drug more than the cost of its production.

In the next transaction, the wholesaler sells the drug to a retail pharmacy at a price reflecting its cost of acquiring the drug plus a markup. The retail level of the distribution chain includes drug chains, independents, and mass merchandisers.

Finally, the pharmacy sells the drug to a consumer at a price that includes its cost for acquiring the drug from the wholesaler plus a retail markup. Part of this markup is a fixed cost that is not even related to the cost of acquiring a specific drug, and is oftentimes higher for independent pharmacies than for chain pharmacies or mass merchandisers. This is because the cost to the pharmacy of filling a prescription for a low-priced drug is likely to be the same as for a high-priced drug. As a result, the fixed cost is a higher percentage markup over acquisition cost for a low-price drug than for a high-price one. In addition, cash customers (i.e., those without insurance coverage and those with indemnity coverage) generally pay more for a given drug than those with third-party payments at the point of sale.

In one method of providing pharmaceutical services to a customer, a customer places an order for a pharmaceutical product with a covered entity, wherein the covered entity is one that is participating in a government program such as the Public Health Services Act. The covered entity then places the order with a contract pharmacy and transfers an account receivable of the customer to the contract pharmacy. The contract pharmacy places the order with a manufacturer and receives the order at a discount price, since the order is through a covered entity. The contract pharmacy sends the order back to the covered entity to administer the order and the contract pharmacy pursues compensation from the customer or the customer's insurance company. In another such method, cost savings are distributed to participants in a prescription drug distribution chain. When one participant selects a generic drug over a brand or other more expensive drug, the price difference is determined and distributed to all of the participants.

Therefore, there are many complex factors that should be considered before establishing a price for a drug sold to a consumer. Further, such factors may fluctuate over time, for example, if a new brand name drug or a new generic drug is introduced into a market, which will also affect the pricing of drugs. While there are pharmaceutical pricing systems that assist in the pricing of drugs, such pricing systems generally require specific pricing information that must be calculated for each drug, such as, an average wholesale price, a median sales price, and a gross profit percentage. Additionally, such information can further be broken down into a type of retail pharmacy and/or a type of transaction, for example, and should be updated periodically. As a result, it can be a complex and time-consuming task just to compile the information supplied to pharmaceutical pricing systems. Consequently, a need exists for a more efficient and reliable way of providing such information to pharmaceutical pricing systems.

### SUMMARY OF THE INVENTION

According to one aspect, a method of creating an electronic pricing schedule for use by a pharmaceutical pricing system includes the steps of determining an average wholesale price (“AWP”) for a quantity of a drug, determining a median sales price (“MSP”) for the quantity of the drug, wherein the MSP is based on historical sales data, and determining a discount rate based on the quantity of the drug. The method further includes the steps of calculating a gross profit percentage (“GP %”), wherein the GP % is based on the AWP, the MSP, and the discount rate, and generating an electronic pricing schedule, wherein the drug is associated with the GP %.

According to another aspect, a method of creating an electronic pricing schedule for use by a pharmaceutical pricing system includes the steps of determining an average wholesale price (“AWP”) for a quantity of a drug, determining a median sales price (“MSP”) for the quantity of the drug, wherein the MSP is based on historical sales data, and determining a discount rate based on the quantity of the drug. The method also includes the steps of calculating a gross profit percentage (“GP %”), wherein the GP % is based on the AWP, the MSP, and the discount rate, and repeating the steps of determining an AWP, determining an MSP, determining a discount rate, and calculating a GP % for a plurality of drugs. Further, the method includes the steps of generating an electronic pricing schedule, wherein each of the plurality of drugs is associated with a corresponding GP %, and conveying the electronic pricing schedule to a customer for use in a pharmaceutical pricing system to price the plurality of drugs.

According to yet another aspect, a computer-readable medium that stores a program executable by one or more processing devices to create an electronic pricing schedule for use by a pharmaceutical pricing system includes a first routine that receives an average wholesale price (“AWP”) for a quantity of a drug, a second routine that receives a median sales price (“MSP”) for the quantity of the drug, wherein the MSP is based on historical sales data, and a third routine that determines a discount rate based on the quantity of the drug. The computer-readable medium further includes a fourth routine that calculates a gross profit percentage (“GP %”), wherein the GP % is based on the AWP, the MSP, and the discount rate, and a fifth routine that generates an electronic pricing schedule, wherein the drug is associated with the GP %.

Other aspects and advantages of the present invention will become apparent upon consideration of the following detailed description.

### BRIEF DESCRIPTION OF THE DRAWINGS

FIG. 1 is a flowchart that can be executed to create a pricing schedule for use by a pharmaceutical pricing system;

FIG. 2 is a block diagram that shows an example of a system that is capable of implementing the flowchart of FIG. 1;

FIG. 3 illustrates example pricing tables and an example discount table;

FIG. 4 is an example screen shot that shows market data for a drug; and

FIG. 5 is an example pricing schedule.

### DETAILED DESCRIPTION

Turning now to the drawings, FIG. 1 illustrates a flowchart 10 that can be executed to create a pricing schedule for use by a pharmaceutical pricing system to price brand name and/or generic drugs. Control begins at a block 12 that creates one or more pricing tables. Each pricing table corresponds generally to a base gross profit percentage (“GP %”), either a gain or a loss, which can be associated with a particular drug. Typically, the GP % is designated by integers, e.g., a gain of 1%, 2%, 3%, etc. or a loss of 1%, 4%, 20%, etc. However, in other embodiments, the GP % can include fractional or decimal components. In one embodiment, a plurality of standard pricing tables, e.g., 55 standard pricing tables, are created a single time by the block 12 and used repeatedly when the flowchart 10 is executed. Further, the block 12 creates a discount table. The discount table designates a discount percentage or rate that is applied to a drug based on the prescribed quantity of the drug. For example, if the prescribed quantity is between 30 and 35 units, wherein each unit is, for example, a single pill, tablet, dose, etc., then a discount of 4% is applied to the price of the drug. Generally, the greater the prescribed quantity of the drug, the greater the discount percentage. For example, if the prescribed quantity is between 60 and 79, then a discount of 8% may be applied to the price of the drug. In other embodiments, the block 12 can create a plurality of different discount tables, as would be apparent to one of ordinary skill in the art.

Following the block 12, control passes to a block 14, which receives market data for one or more drugs. In one embodiment, the market data includes an average wholesale price (“AWP”) and a median sales price (“MSP”) for a plurality of drugs in a given geographic area or market. The AWP is a published wholesale price or list price suggested by a wholesaler or a distributor of the drug and the MSP is based on historical sales data for the drug. The AWP is often used by pharmacies as a cost basis for pricing drugs; however, the AWP does not usually represent the actual or acquisition cost for the pharmacy to purchase the drug. In general, the AWP and MSP are based on a prescribed quantity of each drug, wherein a price per unit of the drug normally varies depending on the prescribed quantity. For example, if the prescribed quantity is 30, then a price per unit may be higher then if the prescribed quantity is 90. Such decrease in price per unit as the prescribed quantity increases is generally referred to as the discount percentage or rate. The market data may be obtained from third party sources or can be developed independently. In one example, the market data may be acquired from various sources, including First DataBank, Inc. of San Bruno, Calif., and RelayHealth of Atlanta, Ga.

As stated above, the block 14 can receive the market data for a plurality of drugs in a given geographic area. The given market can be defined by a zip code, city, state, geographic region, or any other suitable definition. In one embodiment, the given geographic area is defined by the first two or three digits of the zip code and the market data is obtained for the top 2100 drugs sold in the geographic area.

The market data received during the block 14 can also include additional information, such as, a breakdown of AWP and MSP data by a type of retailer and/or a type of transaction. For example, different retailers may include a chain drugstore, an independent retailer, and a mass merchandiser. Examples of the type of transaction may include sales to cash customers, sales to third parties, or sales through a covered entity participating in the Public Health Services Act. Still further, the market data can rank each of the drugs according to the sales position by volume or total sales of the drug in the given geographic area.

After the block 14, control passes to a block 16, which processes the market data received at the block 14 to assign or associate a pricing table to each drug. More specifically, the market data is processed according to a formula that calculates a GP % for each drug based on a sliding scale. The sliding scale is provided using the discount rate in the formula. In the present example, the GP % for a quantity of a drug is calculated using the following equation: [MSP/(discount)]/AWP=GP %, wherein the discount value is a discount rate obtained from the discount table created at the block 12. In one embodiment, the block 14 rounds the GP % to the nearest integer and assigns the drug to a corresponding pricing table based on the rounded GP %. In other embodiments, the GP % can be left as a fraction and assigned to a pricing table, as would be apparent to one of ordinary skill.

Next, control passes to a block 18, which obtains unique identifiers for the drugs. The unique identifiers may, for example, include a generic product identifier (“GPI”), a national drug code (“NDC”), a generic number code (“GNC”), a generic sequence number (“GSN”), and the like. The actual unique identifiers obtained may depend on the source of such information. Generally, the unique identifiers are specific to a drug, manufacturer, and package size. In some cases, the unique identifiers are also specific to different dosage forms, strengths, routes of administration, and other factors. A block 20 processes the unique identifiers for the drugs so that each drug has a standardized identifier in a consistent format. Such standardized identifiers should be in a format that can be used across different pharmaceutical pricing systems, such as with Pharmaserv®, a product offered by McKesson Pharmacy Systems of Livonia, Mich., or other pricing and accounting systems offered by such companies as Rx30 of Ocoee, Fla., QS/1 of Spartanburg, S.C., and Compusolv DMC, Inc. of North Canton, Ohio. In one embodiment, a form of the NDC number, such as an eleven digit NDC number, is used as the standardized identifier. However, in other embodiments, the GPI, GNC, GSN, or modifications thereof can be used as the standardized identifier.

A block 22 creates a current pricefile that associates the standardized identifier for each drug with a pricing table in accordance with the processing performed by the block 16. The pricefile may function as the pricing schedule that is used by a pharmaceutical pricing system to calculate the price of a drug. In one embodiment, the block 22 may compare a previous pricefile, e.g., a pricefile from a previous month, with the current pricefile and identify drugs that were on the previous pricefile but not in the current pricefile. Such drugs, e.g., drugs that fell out of the top 2100 drugs sold in a geographic area, can be added to the current pricefile and associated with a default pricing table, as will be described in more detail hereinafter. Alternatively, the added drugs can be associated with some other pricing table, e.g., the same pricing table from the previous pricefile.

Following the block 22, a block 24 can be implemented to prepare a pharmaceutical pricing system of a customer before loading the current pricefile. The block 24 processes the pharmaceutical pricing system of the customer by analyzing and storing existing drug records, comparing the existing drug records to the previous pricefile and/or the current pricefile, and deleting outdated or irrelevant drug records from the pharmaceutical pricing system. Following the block 24, a block 26 can load the current pricefile to the pharmaceutical pricing system. The blocks 24 and 26 can be modified in other embodiments, e.g., the block 24 can be omitted and the block 26 performed to load the current pricefile and overwrite any existing data.

After the current pricefile is loaded to the pharmaceutical pricing system of the customer, a block 28 can calculate the price of one or more drugs by utilizing the pharmaceutical pricing system. In one example, the following formula is used to calculate the price: AWP*GP %, wherein the current pricefile provides a pricing table for the drug, and wherein the pricing table is used to determine the GP % for a certain quantity of the drug.

Referring generally to FIG. 1, the flowchart 10 may be executed repeatedly on a periodic basis to update the current pricetable and to provide the updated pricetable to the pharmaceutical pricing system for the customer. By way of illustration only, an updated pricetable can be created and loaded to the pharmaceutical pricing system on a monthly, quarterly, yearly, or weekly basis. In addition, the blocks 12-28 of the flowchart 10 can be omitted or modified or additional blocks may be included, as would be apparent to one of ordinary skill in the art. Alternatively or in conjunction, the order of the blocks can be rearranged or one or more of the blocks can be performed concurrently with one another.

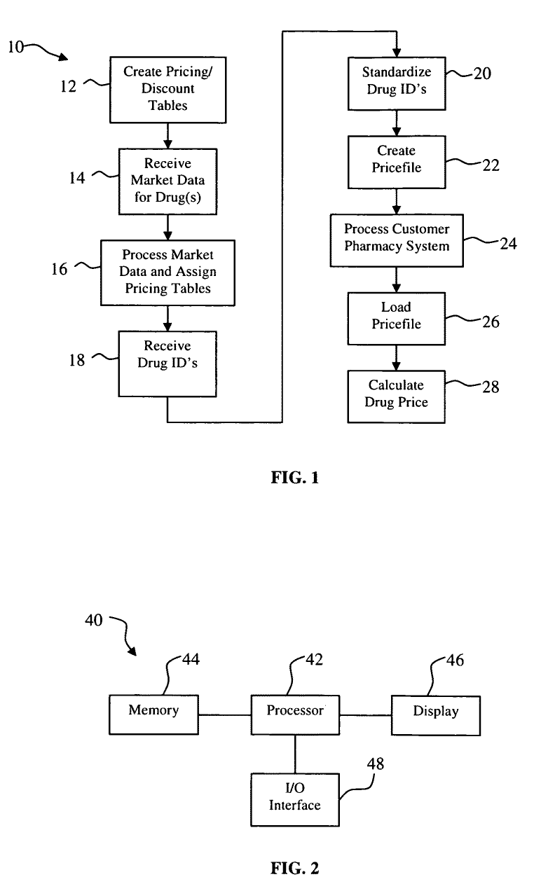

FIG. 2 shows one embodiment of a system 40 that can implement the flowchart 10 of FIG. 1. In FIG. 2, the system 40 includes a processor 42 coupled to a memory 44, a display 46, and an I/O interface 48. By way of non-limiting example, the system 40 can be implemented as a personal computer with suitable hardware and software adapted to run an appropriate operating system, e.g., Microsoft Windows, Mac OS, Linux, etc., as would be apparent to one of ordinary skill in the art. The processor 42 controls the operation of the system 40 in accordance with programming and suitable applications stored in the memory 44 and instructions received through one or more input devices (not shown) coupled to the I/O interface 48. For example, the processor 42 controls the display 46 to display information, such as market data for one or more drugs, to facilitate the manipulation of such information by a user. Programming stored by the memory 44 may include the flowchart of FIG. 1 programmed in a software language, such as Visual Basic, Java, or other language compliant with American National Standards Institute Standard 256, and suitable applications stored by the memory 44 may include relational database software such as the Windows-based Microsoft ACCESS database, as well as, ORACLE, SYBASE, and INFORMIX database software. Various examples of input/output devices (not shown) that can be coupled to the I/O interface 48 include without limitation, a keyboard, a mouse, a flash memory drive, a CD or DVD drive, a printer, etc. Further, in another example, the system 40 is configured to send information to one or more other similar or different systems via a wired or wireless connection.

FIG. 3 shows examples of pricing tables 60a, 60b, and 60c and an example of a discount table 62 that can be created at the block 12 of FIG. 1. Referring to the pricing tables 60a-60c, each table includes a name block 64 that generally specifies an associated base GP %. For example, the NO table 60a specifies a 0% base GP %, the P+20 table 60b specifies a positive 20% base GP %, and the DEFAULT table 60c specifies a default positive 41% base GP %. Each pricing table 60a-60c also includes a MIN column 66, a MAX column 68, and a “%” column 70. The MIN column 66 and the MAX column 68 are divided into a plurality of rows 72 that designate different ranges of prescribed quantities of the drug and the “%” column 70 designates a GP % on a sliding scale for each of the different ranges of quantities. For example, in the NO table 60a, if the prescribed quantity of the drug is 30, then the GP % is −4, i.e., a multiplier of 96%. In other examples, in the P+20 table 60b, if the quantity of the drug is 60, then the GP % is 12, i.e., a multiplier of 112%, and if the quantity if greater than 100, then the GP % is 10%, i.e., a multiplier of 110%.

Referring to the DEFAULT table 60c, a fixed markup fee 74 can also be included and added to the price of the drug regardless of the prescribed quantity. In the present example, the fixed markup fee 74 is $5.68, which can be modified as desired. In one embodiment, the DEFAULT table 60c can be associated with drugs that have a GP % that lies outside of any of the other pricing tables, e.g., drugs that have a GP % greater than 200% and/or drugs that were listed in a previous pricefile but not for a current pricefile.

The discount table 62 of FIG. 3 also includes the name block 64, the MIN column 66, the MAX column 68, and the % column 70. Like the pricing tables 60a-60c, the MIN column 66 and the Max column 68 of the discount table 62 are divided into a plurality of rows 72 that designate different ranges of prescribed quantities of the drug. However, in the discount table 62, the % column 70 designates a discount rate for each of the different ranges. For example, if the quantity is 30, then the discount rate is −4, i.e., a multiplier of 96%, while if the quantity is 90, then the discount rate is −9, i.e., a multiplier of 91%.

In the pricing tables 60a-60c and the discount table 62, the quantities are divided into 11 ranges and the GP % and the discount rate decrease by one percent with each increase in range. However, various modifications can be made to pricing tables 60a-60c and the discount table 62 without departing from the spirit of the present disclosure, e.g., the ranges can be modified, a fewer or a greater number of different ranges can be used, and/or the GP % and the discount rate can be increased or decreased by any fractional or integer percentage value. Further, additional pricing tables can be created that correspond to a wide range of GP % and/or a plurality of different discount tables 62 can be created.

In one embodiment, the discount table is used a single time in the block 16 of FIG. 1 and the pricing tables 60 incorporate the discount rate, as seen in the pricing tables 60a-60c, wherein the GP % mirrors the discount rates in the discount table 62 and decreases by one percentage point with each increase in range. Consequently, when the drug price is calculated at the block 34 of FIG. 1, only the AWP and the GP % from the pricing tables 60 are needed because the pricing tables incorporate a sliding scale based on the discount table 62. In a different embodiment, the pricing tables may only include a base GP %, e.g., the P+20 table only includes a base GP % of 20%, wherein a discount rate from the discount table 62 is used during the block 34 of FIG. 1 to calculate the drug price for a given quantity using the following formula: AWP*GP %*discount.

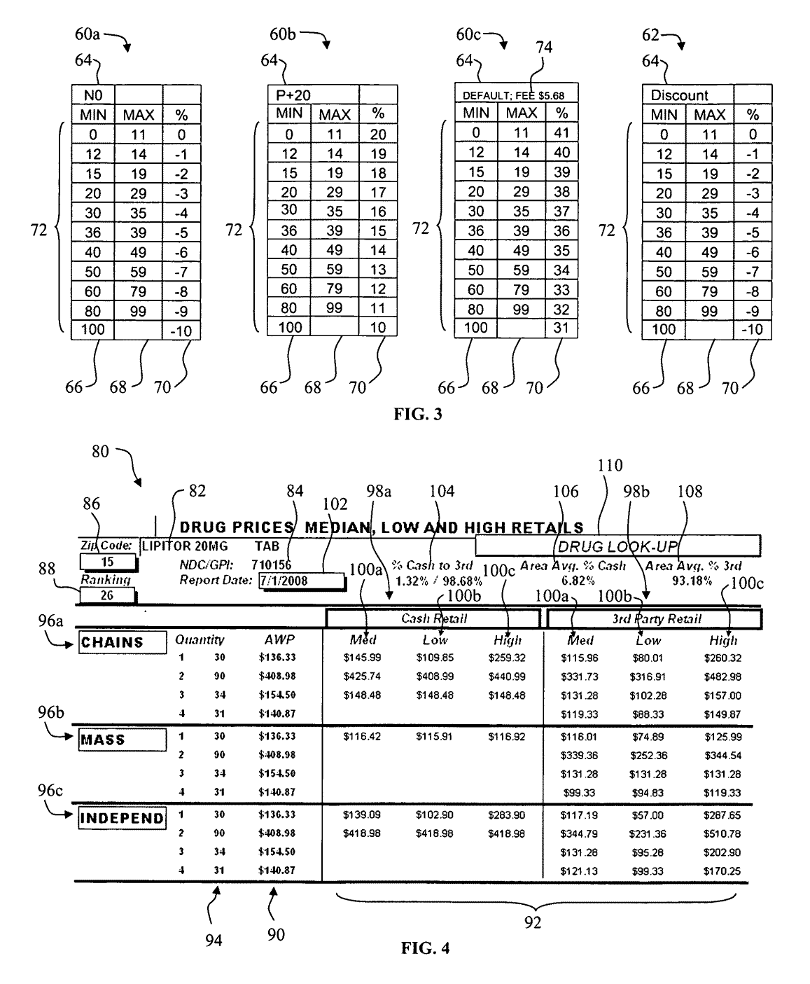

FIG. 4 illustrates an example of a screen shot 80 displayed by the system 40 of FIG. 2 that includes market information for a drug, such as the market information received by the block 14 of FIG. 1. In the screen shot 80, a box 82 lists a description of a specific drug, which in the present non-limiting example is “Lipitor 20 mg TAB.” Further, a NDC/GPI identifier 84 for the drug is also listed. In the present embodiment, the NDC/GPI number 84 is shown with leading zeros truncated. In other embodiments, other unique identifiers can be used, e.g., the GSN or the GNC.

A box 86 lists a geographic area under consideration, which in the present example is specified by the first two digits of a zip code that defines the geographic area. A box 88 includes a specific sales ranking of the drug in the geographic area. The screen shot 60 also includes the AWP 90 and sales information 92 for the drug. The AWP 90 and sales information 92 are divided into a plurality of rows based on a column 94 that lists different quantities of the drug. Further, the AWP 90 and sales information 92 is divided into a plurality of groups of rows that correspond to different types of retailers. In the present example, the screen shot 80 includes a group of rows for chain drugstores 96a, a group of rows for mass merchandisers 96b, and a group of rows for independent retailers 96c. Within each group of rows 96a-96c, the column 94 lists the four most prescribed quantities of the drug, e.g., 30, 90, 34, 31. The sales information 92 can also be divided into different columns based on a type of transaction. In FIG. 4, the sales information 92 is divided into a cash retail column 98a and a third party retail column 98b. Still further, each column 98a, 98b is divided into a MSP 100a, a low sales price 100b, and a high sales price 100c for the geographic area. The screen shot 80 also includes additional information, such as a report date 102, a cash to third party ratio 104, an area average cash percentage 106, and an area average third party ratio 108. The cash to third party ratio 104 includes two percentages, the first is the ratio for the drug overall and the second is the ratio for the drug in the geographic area. Further, the screen shot 80 includes a drug look-up button 110 that a user can click on to select a different drug, as would be apparent to a person of skill in the art. In other embodiments, the screen shot 80 can include a lesser or greater amount of information, such as other different types of transactions and an acquisition cost for a drug.

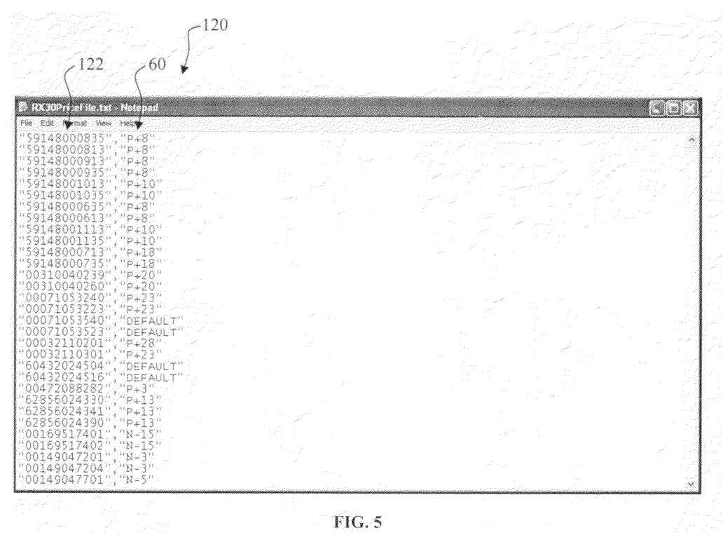

Referring to FIG. 5, a pricing schedule 120 is shown, such as the pricefile created at the block 22 of FIG. 1. Each line of the pricing schedule 120 includes a standardized identifier 122 for a drug associated with a pricing table 60. In the present embodiment, an 11-digit NDC number is used as the standardized identifier. However, as discussed above, in other embodiments it may be appropriate to use other standardized identifiers. The pricing schedule 120 in the present embodiment is a list saved as a Notepad file. However, in other embodiments, the pricing schedule 120 may be stored in a database, spreadsheet, text file, or any other appropriate format. In general, the format of the pricing schedule 120 will be compatible with the pharmaceutical pricing system of the customer. In the present embodiment, the pricing schedule 120 lists standardized identifiers for all of the relevant drugs in a geographic area, e.g., a list of 61,000 drugs. However, a lesser or greater amount of drugs can be listed in the pricing schedule 120 in other embodiments.

### INDUSTRIAL APPLICATION

The method of creating a pricing schedule for use by a pharmaceutical pricing system of the present invention assigns drugs to various standard pricing tables based on a sliding scale that accounts for the average wholesale price, median sales price, and discount rate for a drug. This method is advantageous because it assists pharmacies in establishing competitive and profitable pricing strategies.

The invention has been described in an illustrative manner in order to enable a person of ordinary skill in the art to make and use the invention, and the terminology used is intended to be in the nature of description rather than of limitation. It is understood that the invention may be practiced in ways other than as specifically described, and that all modifications, equivalents, and variations of the present invention, which are possible in light of the above teachings and ascertainable to a person of ordinary skill in the art, are specifically included within the scope of the appended claims.

I claim:

1. A method of creating an electronic pricing schedule for use by a pharmaceutical pricing system, the method comprising the steps of:
determining an average wholesale price (“AWP”) for a quantity of a drug;
determining a median sales price (“MSP”) for the quantity of the drug, wherein the MSP is based on historical sales data;
determining a discount rate based on the quantity of the drug;
calculating a gross profit percentage (“GP %”), wherein the GP % is based on the AWP, the MSP, and the discount rate; and
generating an electronic pricing schedule, wherein the drug is associated with the GP %.

2. The method of claim 1, wherein the step of calculating further includes the steps of dividing the MSP by the discount rate to obtain a first result and dividing the first result by the AWP to obtain a second result, and wherein the second result is used to calculate the GP %.

3. The method of claim 2, further comprising the step of rounding the second result to a nearest percentage point to obtain the GP %.

4. The method of claim 1, further comprising the step of accessing a discount table to determine the discount rate for the quantity of the drug, wherein the discount rate varies based on the quantity of the drug.

5. The method of claim 1, further comprising the step of generating a plurality of pricing tables, wherein the GP % for the drug is associated with a selected pricing table and the drug is associated with the selected pricing table in the electronic pricing schedule.

6. The method of claim 5, wherein each pricing table specifies a different GP % based on different quantity ranges of the drug.

7. The method of claim 6, further comprising the step of determining an actual sale price for the quantity of the drug by multiplying the AWP times a GP % for the quantity range of the drug obtained from the selected pricing table.

8. The method of claim 1, further comprising the step of determining an actual sale price for the quantity of the drug by multiplying the AWP times the GP % and times a discount rate for the quantity of the drug.

9. The method of claim 1, wherein the steps of determining an AWP, determining an MSP, determining a discount rate, and calculating a GP % are performed for a plurality of drugs, and wherein each of the plurality of drugs is associated with a corresponding GP % in the electronic pricing schedule.

10. A method of creating an electronic pricing schedule for use by a pharmaceutical pricing system, the method comprising the steps of:
determining an average wholesale price (“AWP”) for a quantity of a drug;
determining a median sales price (“MSP”) for the quantity of the drug, wherein the MSP is based on historical sales data;
determining a discount rate based on the quantity of the drug;
calculating a gross profit percentage (“GP %”), wherein the GP % is based on the AWP, the MSP, and the discount rate;
repeating the steps of determining an AWP, determining an MSP, determining a discount rate, and calculating a GP % for a plurality of drugs;
generating an electronic pricing schedule, wherein each of the plurality of drugs is associated with a corresponding GP %; and
conveying the electronic pricing schedule to a customer for use in a pharmaceutical pricing system to price the plurality of drugs.

11. The method of claim 10, wherein the step of calculating further includes the steps of dividing the MSP by the discount rate to obtain a first result and dividing the first result by the AWP to obtain a second result, and wherein the second result is used to calculate the GP %.

12. The method of claim 10, further comprising the step of accessing a discount table to determine the discount rate for the quantity of the drug, wherein the discount rate varies based on the quantity of the drug.

13. The method of claim 10, further comprising the step of generating a plurality of pricing tables, wherein the GP % for the drug is associated with a selected pricing table and each of the plurality of drugs is associated with a selected pricing table in the electronic pricing schedule.

14. The method of claim 10, wherein each of the steps are performed periodically for the customer to update the electronic pricing schedule.

15. A computer-readable medium that stores a program executable by one or more processing devices to create an electronic pricing schedule for use by a pharmaceutical pricing system, comprising:
a first routine that receives an average wholesale price (“AWP”) for a quantity of a drug;
a second routine that receives a median sales price (“MSP”) for the quantity of the drug, wherein the MSP is based on historical sales data;
a third routine that determines a discount rate based on the quantity of the drug;
a fourth routine that calculates a gross profit percentage (“GP %”), wherein the GP % is based on the AWP, the MSP, and the discount rate; and
a fifth routine that generates an electronic pricing schedule, wherein the drug is associated with the GP %.

16. The computer readable medium of claim 15, wherein the fourth routine further includes a sixth routine that divides the MSP by the discount rate to obtain a first result and divides the first result by the AWP to obtain a second result, and wherein the second result is used to calculate the GP %.

17. The computer readable medium of claim 15, wherein the third routine accesses a discount table to determine the discount rate for the quantity of the drug, wherein the discount rate varies based on the quantity of the drug.

18. The computer readable medium of claim 15, further comprising a sixth routine that generates a plurality of pricing tables, wherein the fourth routine associates the GP % for the drug with a selected pricing table and the fifth routine associates the drug with the selected pricing table in the electronic pricing schedule.

19. The computer readable medium of claim 18, wherein each pricing table specifies a different GP % based on different quantity ranges of the drug, and wherein the computer readably medium further comprises a seventh routine that determines an actual sale price for the quantity of the drug by multiplying the AWP times a GP % for the quantity range of the drug obtained from the selected pricing table.

20. The computer readable medium of claim 15, wherein the first, second, third, and fourth routines are performed for a plurality of drugs, and wherein each of the plurality of drugs is associated with a corresponding GP % in the electronic pricing schedule.
